(19) United States
(12) Patent Application Publication
(10) Pub. No.: US 2007/0263835 A1
(43) Pub. Date: Nov. 15, 2007

(54) Telephone system and tetephone exchange apparatus

(75) Inventor: Atsushi Yamazaki, Hino-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/725,479

(22) Filed: Mar. 20, 2007

(30) Foreign Application Priority Data
Mar. 30, 2006 (JP) 2006-095946

(51) Int. Cl. H04M 3/42; H04M 3/00; H04M 5/00

(52) U.S. Cl. 379/243

(57) ABSTRACT

According to one embodiment, a telephone exchange apparatus includes a receiver which receives communication establishment requests transmitted from the SIP terminals via the packet communication network, the communication establishment requests is defied by the SIP; and a controller which determines whether or not service IDs to specify arbitrary service information in order to register the IDS in opposite-party identification information areas of the communication establishment requests in the service management table, and registers the service information specified by the service IDs in the service management table, based on the determination results.

### CROSS-REFERENCE TO RELATED APPLICATIONS

This application is based upon and claims the benefit of priority from the Japanese Patent Application No. 2006-095946, filed Mar. 30, 2006, the entire contents of which are incorporated herein by reference.

### BACKGROUND

1. Field

One embodiment of the present invention relates to a telephone system which makes voice communications among a plurality of session initiation protocol (SIP) terminals having communication functions defied by the SIP, and a telephone exchange apparatus which is used for this telephone system.

2. Description of the Related Art

In recent years, a network telephone system (Internet protocol (IP) telephone system) which interactively transmits and receives images and voices as packet data in real time via a packet network has become widely used.

This type of system pre-registers the addresses of terminals connected to the packet network (herein after, referred to as SIP terminals) in the telephone exchange on the packet network, and makes the telephone exchange authenticate the SIP terminals based on the registered addresses for performing speeches among the SIP terminals.

Now, even in the foregoing telephone system, an additional origination/termination service, for example, incoming call transfer, etc., which has been implemented by a private branch exchange (PBX) or a key telephone device, has been strongly desired. In such a case, the telephone system has to pre-register the services expected to be used in the telephone exchange for each SIP terminal. As to its registration method, the telephone system connects the SIP terminals on an origination side to the telephone exchange. The telephone exchange transmits input instructions of service numbers corresponding to the services desired by a caller to the SIP terminals on the origination side. When the caller transmits the service number consisting of a dual tone multi frequency (DTMF) signal by means of a dial operation, the registration method detects the DTMF signal and allows registering the service number.

However, in the aforementioned registration method, the method needs to provide a DTMF detection circuit for the telephone exchange. In general, the DTMF detection circuit is apt to become complex and large in circuit configuration and to result in an increase in its price. Conventionally, a method for achieving a service function by adding a feature extension to a “REGISTER” message has been proposed (for instance, Jpn. Pat. Appln. KOKAI Publication No. 2003-517764).

However, the foregoing method having made the SIP terminals execute generation processing and addition processing of the feature extension, the SIP terminals are required to conduct complex processing and it results in an increase in a processing load.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view of an IP telephone system regarding a first embodiment of the present invention;

FIG. 2 is an exemplary block view depicting a functional configuration of a private branch exchange depicted in FIG. 1;

FIG. 3 is an exemplary view depicting an example of storage contents in a service registration table depicted in FIG. 2;

FIG. 4 is an exemplary sequence view depicting transmitting/receiving operations of information among the private branch exchange and SIP terminals for conducting service registration performing in the first embodiment;

FIG. 5 is an exemplary block diagram depicting a functional configuration of a private branch exchange as a second embodiment in the invention; and

FIG. 6 is an exemplary flowchart depicting a control processing procedure of the private branch exchange in performing service registration determination in the second embodiment.

### DETAILED DESCRIPTION

Various embodiments according to the invention will be described hereinafter with reference to the accompanying drawings, In general, according to one embodiment of the invention, a telephone system, comprising: a plurality of session initiation protocol (SIP) terminals which are connected to a packet communication net work and respectively have communication functions defied by the SIP; and a telephone exchange apparatus which executes exchange processing among the plurality of SIP terminals, and executes functions selected based on service information registered in a service management table when service information on arbitrary functions is registered in the service management table, the service information on arbitrary functions are out of a plurality of items of service information to execute functions differing from one another by means of the SIP terminals, wherein the SIP terminals respectively include transmitters which insert service IDs specifying arbitrary service information into opposite-party identification information areas of communication establishment requests specified by the SIP to register the IDs in service management table and transmit the IDs to the telephone exchange apparatus in executing arbitrary functions; and the telephone exchange apparatus includes a controller which registers the service information specified by the corresponding service IDs in the service management table, when the service IDs are inserted into opposite-party identification information areas of the received communication establishment request.

### First Embodiment

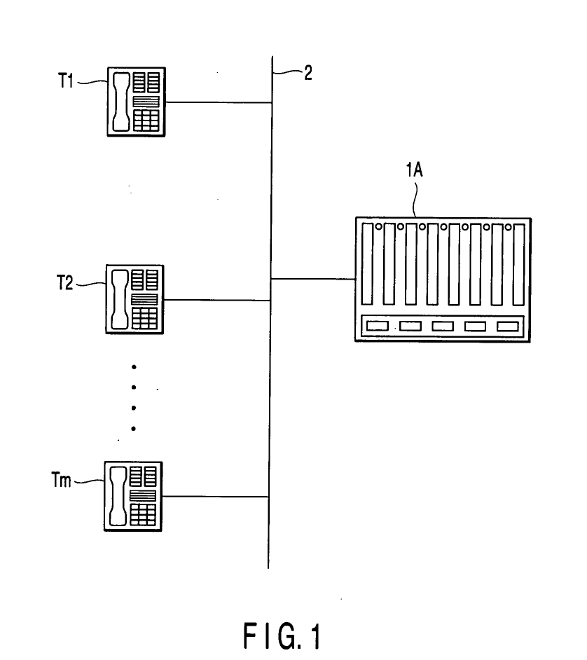

FIG. 1 is a schematic configuration view of an IP telephone system regarding a first embodiment of the invention, and a symbol “1A” indicates a private branch exchange.

The exchange apparatus 1A accommodates a plurality of SIP terminals T1 to Tm (m is natural number) via a local area network (LAN) 2.

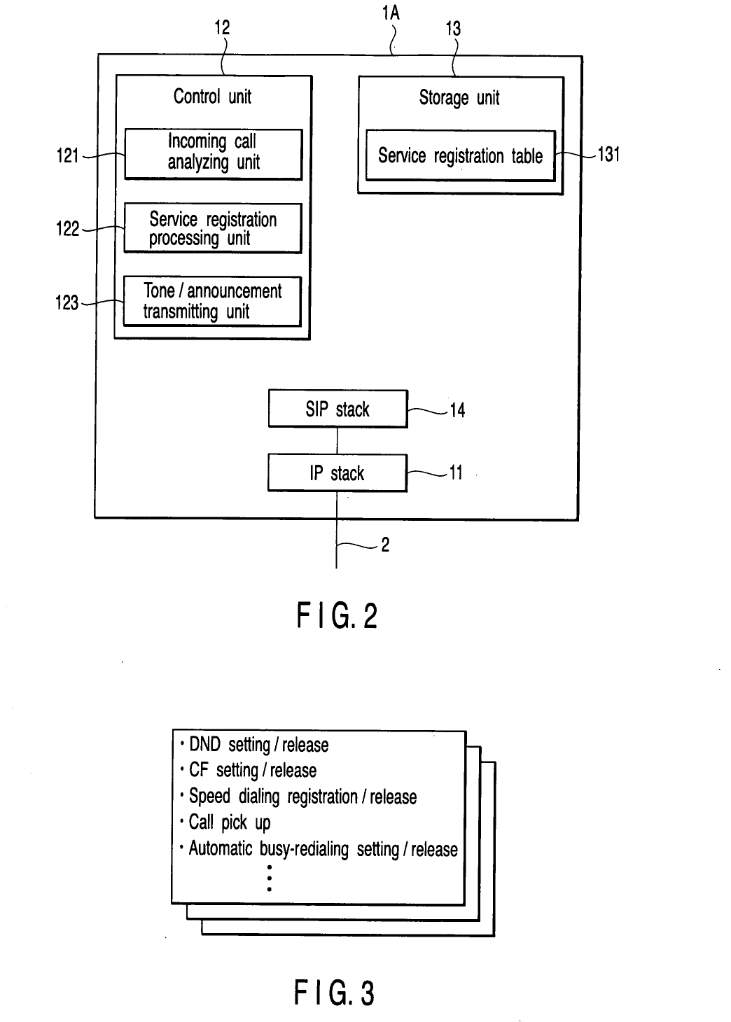

FIG. 2 is a block diagram illustrating a functional configuration of the private branch exchange apparatus 1A.

The exchange apparatus 1A includes an IP stack 11, a control unit 12, a storage unit 13, and an SIP stack 14. The IP stack 11 conducts interface processing to and from the LAN 2.

In a service unit 13, routing information, etc., necessary for connection control by the control unit 12 is stored. Further, the storage unit 13 is provided with a service registration table 131.

In the service registration table 131, as shown in FIG. 3, setting information indicating setting/release of services usable for each SIP terminal T1 to Tm is stored.

On the other hand, the control unit 12 includes an incoming call analyzing unit 121, a service registration processing unit 122 (hereinafter, referred to as registration processing unit 122), and a tone/announcement transmitting unit 123 as new functions to be added to this invention in addition to an exchange connecting function among each SIP terminal T1 to Tm, and among the SIP terminal T1 to Tm and non-SIP terminals (not shown), or to and from subscriber's lines on a public network (not shown).

When receiving SIP messages (INVITEs) from respective SIP terminals T1 to Tm, the incoming call analyzing unit 121 determines whether or not each service number (service ID) of registration requests are inserted into each opposite-party identification information area in each of the “INVITEs”.

When the analyzing unit 121 determines that the service numbers are inserted, the registration processing unit 122 updates the setting information of services corresponding to the desired service numbers in the service registration table 131 from “setting” to “release”, or from “release” to “setting”.

The tone/announcement transmitting unit 123 notifies the results of the service registration by the registration processing unit 122 to the SIP terminals T1 to Tm that are request sources by means of tone or voice announcement through sessions established on the LAN 2.

The SIP stack 14 conducts interface processing to and from the SIP terminals T1 to Tm.

Next, operations of the IP telephone system in the aforementioned configuration will be described.

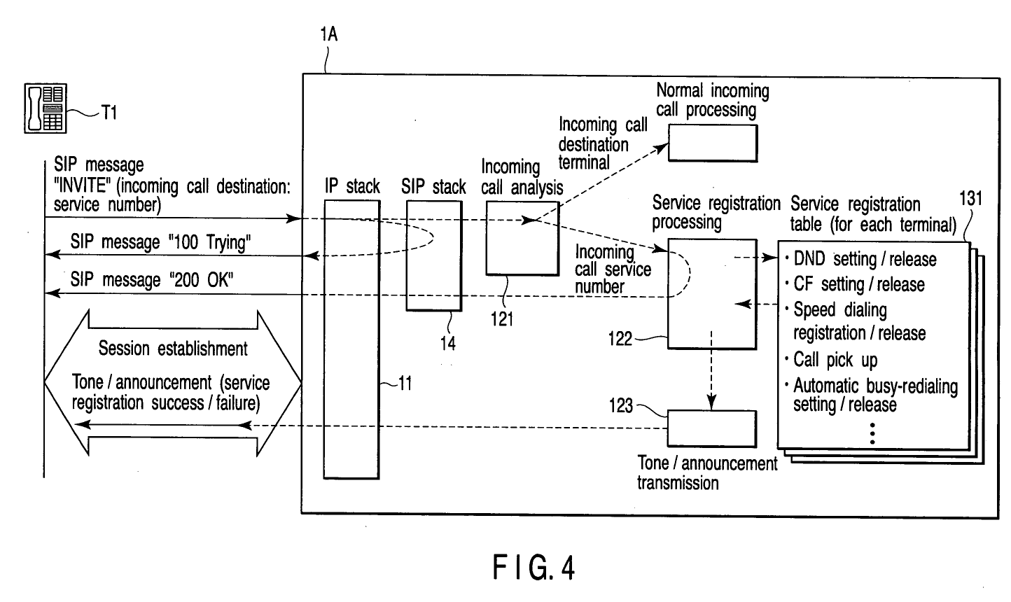

FIG. 4 is a sequence view illustrating transmitting/receiving operations of the information between the private branch exchange apparatus 1A and the SIP terminal T1 in performing service registration processing.

It is presumed that a user of the SIP terminal T1 dial-operates an arbitrary service number by using the SIP terminal T1. The SIP terminal then inserts a desired service number into the “INVITE” defined by the SIP, i.e., an opposite party identification information area of a communication establishment request, and transmits the “INVITE” to the exchange apparatus 1A.

When receiving the “INVITE” from the SIP terminal T1, the exchange apparatus 1A analyzes the “INVITE” by means of the incoming call analyzing unit 121 via the IP stack 11 and the SIP stack 14.

When performing incoming call analysis for the opposite-party identification information area in the “INVITE”, i.e., the incoming call destination, and if the incoming call destination is an SIP terminal, the destination is sorted to normal incoming call processing, and if the destination is a service number, it is sorted to the registration processing unit 122.

The registration processing unit 122 returns an SIP message “200 OK” as a response message though the SIP tack 14 and IP stack 11, and it results in establishment between the SIP terminal T1 and the private branch exchange apparatus 1A.

After returning the SIP message “200 OK”, the registration processing unit 122 registers a service in the service registration table 131 in response to a response message.

After this, the registration processing unit 122 notifies the result of the service registration to the SIP terminal T1 by means of the tone or the announcement by using the session between the SIP terminal T1 and the private branch exchange apparatus 1A. Therefore, the user of the SIP terminal T1 can know whether or not the desired service has been registered through this notification.

Thus, if the SIP terminal T1 corresponds to a basic sequence of the SIP, the service becomes possible to be registered in the exchange apparatus 1A.

As mentioned above, the first embodiment utilizes the existing communication establishment request like the “INVITE” defined by the SIP, and registers the desired service on the service registration table 131 of the exchange apparatus 1A.

Accordingly, there is no need to newly prepare a signal exclusive for service registration, such as a DTFM signal and an SIP message “NOTIFY” and to perform the service registration again after establishing the session. A simple processing procedure, thereby, enables direct device registration processing, and improves the operability of the SIP terminal T1.

Further, in the first embodiment, the private branch exchange apparatus 1A changes the setting information on the service of a registration object in the service registration table 131 from “release” to “setting”, or from “setting” to “release” for the registration processing of the service. Accordingly, in comparison to the case in which the service information itself is registered, the service may be registered with ease and in a short time.

Moreover, in the first embodiment, the exchange apparatus 1A notifies the result whether or not the desired service registration has been completed for the SIP terminal T1 that is the registration request source. Therefore, the user of the SIP terminal T1 can confirm whether or not at least the service registration requested by the user itself has been accepted. At that time, if the reason is notified to the user in addition to the determination result of the validity/invalidity of the service registration, in the case in which the service registration has not been accepted, the user can grasp the reason and conduct an appropriate redo operation, etc.

### Second Embodiment

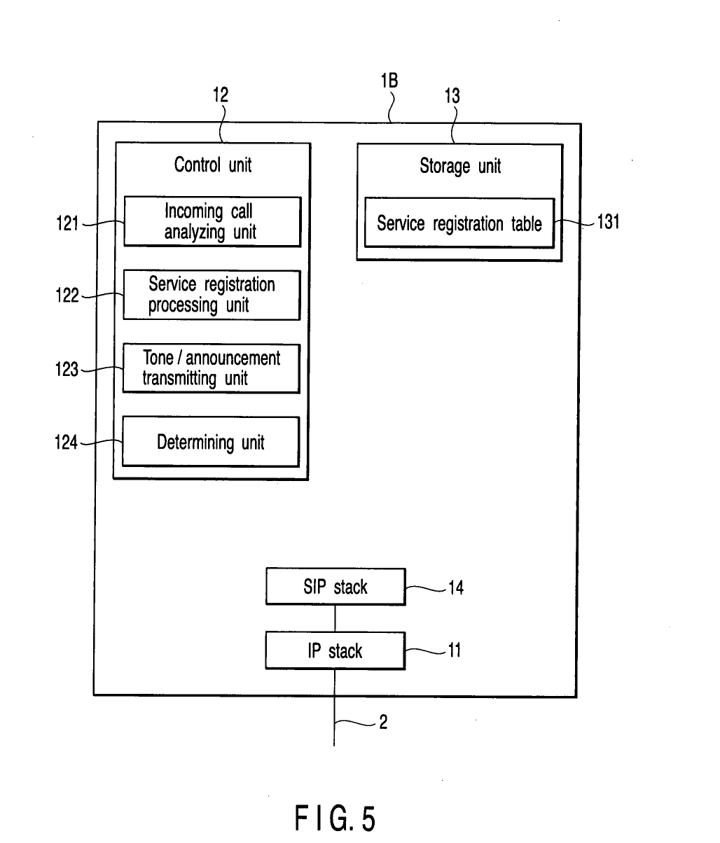

FIG. 5 is a block diagram illustrating a functional configuration of a private branch exchange apparatus 1B as a second embodiment of the present embodiment. In FIG. 5, the same components as those of FIG. 2 are designated by the identical symbols and their detailed descriptions will be omitted.

The control unit 12 includes a determining unit 124. In the case that a service number of a registration request has been inserted into an opposite-party identification information area of an “INVITE”, i.e., a communication establishment request, the determining unit 124 determines the validity/invalidity of the registration of the requested service by comparing the service specified by a service number to the registration service 131 before executing the processing by the service registration processing unit 122.

Next to this, operations in the configuration given above will be set forth.

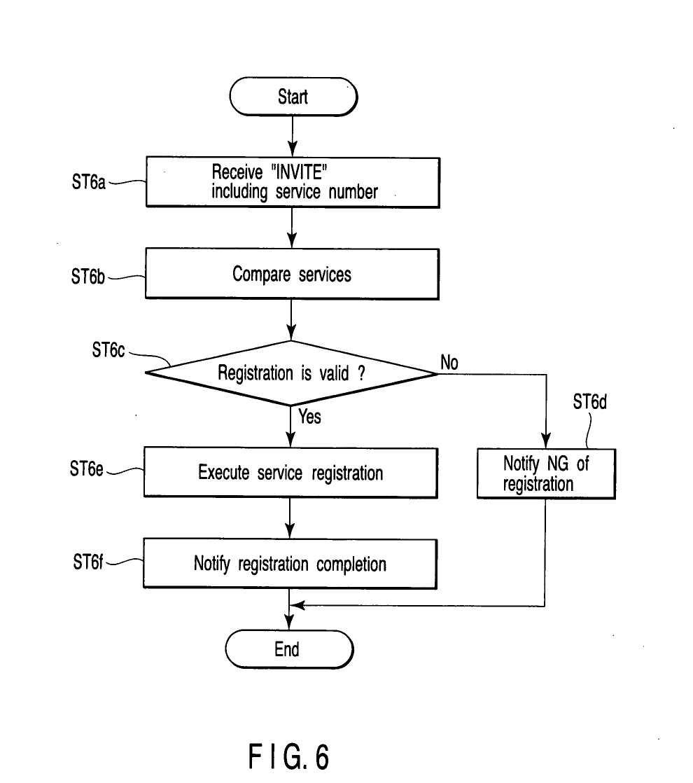

FIG. 6 is a flowchart illustrating the control processing procedure of the exchange apparatus 1B in conducting the service registration determination.

The exchange apparatus 1B shifts from a block ST6a to a block ST6b for every reception of the “INVITEs” with the service numbers of the registration requests inserted therein, and there, compares the received service information to the service information of the registration request registered in the service registration table 131 to determines whether or not the service of the registration request can be registered (block ST6c).

If the registration has been invalid (No), the exchange apparatus 1B notifies a message telling the fact that the registration has not been allowed to the SIP terminal T1 that is the request source (block ST6d).

On the contrary, if the registration has been valid, (Yes), the exchange apparatus 1B updates the setting information of the corresponding service in the service registration table 131 (block ST6e), and after completing the registration, the exchange apparatus 1B notifies the message telling the completion of the registration to the SIP terminal T1 that is the request source (block ST6f).

As mentioned above, in the second embodiment, the private branch exchange apparatus 1B compares the service information specified by the service numbers to the service information of the registration requests in the service registration table 131 before executing the service registrations to the service registration table 131 to determine whether the service registrations are allowed or not, based on the comparison results.

Therefore, appropriate service registration processing may be conducted for each SIP terminal TI to Tm, thereby, the reliability of the service registrations may be further enhanced.

### Other Embodiment

The present invention is not limited to each embodiment given above. For example, in each of the embodiment, if it has a communication function defied by the SIP, the SIP terminal may be a terminal using a wireless LAN, or a soft phone achieved through software on a personal computer.

Each embodiment has described about the example to change each item of the setting information of each service in the service registration table from “setting” to “release”, or from “release” to “setting”, the invention is not limited to these descriptions. However, the invention is not limited to such embodiments, the service information specified by the service numbers may be registered as it is in the service registration table.

Other than this, as for the configuration and type of the telephone system, the configuration and type of the private branch exchange, the type of the phone terminal, the storage contents of the service registration table, the method for controlling the registrations of the services, and the like, this invention may be embodied in various forms without departing from the spirit or scope of the general inventive concept thereof.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system, comprising:
a plurality of session initiation protocol (SIP) terminals which are connected to a packet communication net work and respectively have communication functions defied by the SIP; and
a telephone exchange apparatus which executes exchange processing among the plurality of SIP terminals, and executes functions selected based on service information registered in a service management table when service information on arbitrary functions is registered in the service management table, the service information on arbitrary functions are out of a plurality of items of service information to execute functions differing from one another by means of the SIP terminals, wherein
the SIP terminals respectively include transmitters which insert service IDs specifying arbitrary service information into opposite-party identification information areas of communication establishment requests specified by the SIP to register the IDs in service management table and transmit the IDs to the telephone exchange apparatus in executing arbitrary functions; and
the telephone exchange apparatus includes a controller which registers the service information specified by the corresponding service IDs in the service management table, when the service IDs are inserted into opposite-party identification information areas of the received communication establishment request.

2. A telephone exchange apparatus which executes exchange processing among a plurality of session initiation protocol (SIP) terminals connected to a packet communication network and respectively provided with communication functions defied by SIP, and also executes functions selected based on service information registered in a service management table when service information of arbitrary functions, out of a plurality of items of service information to execute functions differing from one another by means of the SIP terminals and regarding the exchange processing, is registered in the service management table, comprising:
a receiver which receives communication establishment requests transmitted from the SIP terminals via the packet communication network, the communication establishment requests is defied by the SIP; and
a controller which determines whether or not service IDs to specify arbitrary service information in order to register the IDS in opposite-party identification information areas of the communication establishment requests in the service management table, and registers the service information specified by the service IDs in the service management table, based on the determination results.

3. The exchange according to claim 2, when setting information indicating setting/release for at least a part of service information usable by the SIP terminals is stored in the service management table, wherein
the controller changes setting information of arbitrary service information in the service management table based on service IDs when service IDs specifying arbitrary service information are inserted into the opposite-party identification information areas of the communication establishment requests so as to register the IDs in the service management table.

4. The exchange according to claim 2, wherein the controller comprises:
a determining unit which determines validity/invalidity of registrations of requested service information by comparing service information specified by the service IDs to the service management table when service IDs specifying arbitrary service information are inserted so as to register the IDS in the opposite-party identification information areas of the communication establishment requests; and
a registration controller which registers the requested service information in the service management table when it is determined that the registrations of the service information are valid.

5. The telephone exchange according to claim 4, wherein the controller further comprises a notification unit which notifies determination results from the determining unit to SIP terminals that are request sources via the packet communication network.
